(19) United States
(12) Patent Application Publication
(10) Pub. No.: US 2007/0150819 A1
(43) Pub. Date: Jun. 28, 2007

(54) Graphical User Interface

(75) Inventors: Daniel A. Goodman, Windham, NH (US); Michael Toler, Andover, MA (US); Leonid Mindlin, S. Natick, MA (US); Philip W. Sullivan, Lexington, MA (US)

Correspondence Address: MCDERMOTT WILL & EMERY LLP, 28 STATE STREET, BOSTON, MA, 02109-1775, US

(73) Assignee: MKS Instruments, Inc., Wilmington, MA (US)

(21) Appl. No.: 11/301,182

(22) Filed: Dec. 9, 2005

(51) Int. Cl. G06F 17/00

(52) U.S. Cl. 715/749

(57) ABSTRACT

A system for monitoring a sensor includes a GUI (Graphical User Interface) such as a WebPage embedded in the sensor. The GUI is configured to display information relating to the sensor from a user computer connectable to the sensor via an Ethernet connection and having an internet web browser for accessing the WebPage of the sensor. A computer-readable medium is embedded within the sensor and has stored therein computer-usable instructions for a processor. These instructions, when executed by the processor, cause the processor to generate the GUI.

### BACKGROUND

In many applications, the ability to rapidly access the status and/or display the output, and key operating parameters of a sensor may be useful. When using a DPM (Digital Process Manometer) to measure the pressure of gases, for example, such an ability may permit users to easily perform troubleshooting of any system that makes use of the pressure measurements made by the DPM.

In order to access information such as multiple operating parameters for the DPM and historical data of the DPM, users at present may typically use a separate datalogging device or write down the key parameters manually. Alternatively, users may simply have to try to remember such information, when needed.

This attempted recall of information, however, may be subject to human memory issues, relating for example to passage of time, inability to recall specifics, and inability to compare quantitative data. Also, paper recording of specific events or trends may not be easily translated into statistical data for correlation with other process events.

Accordingly, there is a need for a self-contained system that allows for a more expedited access to information relating to the status, output, and operating parameters of sensors.

### SUMMARY

A system for monitoring a sensor may include a GUI (Graphical User Interface) that is accessible using an Ethernet connection to the sensor. The GUI may be configured to display information relating to the sensor from a computer that is connectable to the sensor via a standard Ethernet connection, and has an internet web browser for accessing the WebPage of the sensor. A computer-readable medium may be embedded within the sensor. The computer-readable medium may have stored therein computer-usable instructions for a processor, wherein these instructions, when executed by the processor, may cause the processor to generate the GUI.

A computer-readable medium may have stored therein computer-usable instructions for a processor. The instructions, when executed by the processor, may cause the processor to generate a GUI (graphical user interface) on a user computer connected to the sensor. The GUI may be configured to display information relating to a sensor. The GUI may include a plurality of user-selectable objects, and a plurality of browser windows, each browser window associated with one of the objects. Each of the browser windows may be opened upon selection by a user of the associated object. Each of the browser windows may display, when opened, a corresponding subpage of the WebPage of the sensor. Each subpage may contain a different type of information relating to the sensor.

### BRIEF DESCRIPTION OF THE DRAWINGS

FIG. 1 is a schematic block diagram of one embodiment of a system for monitoring a sensor, including a GUI (graphical user interface) accessible using an Ethernet connection from a computer to the sensor.

FIG. 2A illustrates an e-Baratron Status webpage, in a DPM user mode in one embodiment of the GUI.

FIG. 2B illustrates an e-Baratron Status webpage, in a DPM service mode in one embodiment of the GUI.

FIG. 2C illustrates an e-Baratron Status webpage in a DPM factory mode, in one embodiment of the GUI.

FIG. 2D illustrates an e-Baratron Event webpage in the DPM service mode in one embodiment of the GUI.

FIG. 2E illustrates an e-Baratron Information webpage in the DPM factory mode, in one embodiment of the GUI.

FIG. 3 illustrates a Plot webpage in the DPM user mode, in one embodiment of the GUI.

FIG. 4 illustrates a Diagnostics webpage in the DPM user mode, in one embodiment of the GUI.

FIG. 5A illustrates a Configuration webpage in the DPM user mode, in one embodiment of the GUI.

FIG. 5B illustrates a Configuration Network Settings webpage in the DPM user mode, in one embodiment of the GUI.

FIG. 5C illustrates a Configuration Limit Settings webpage in the DPM user mode, in one embodiment of the GUI.

FIG. 5D illustrates a Configuration Zero Adjustment webpage in the DPM user mode, in one embodiment of the GUI.

FIG. 5E illustrates a Configuration Display Setup webpage in the DPM user mode, in one embodiment of the GUI.

FIG. 6A illustrates a Service webpage in the DPM service mode, in one embodiment of the GUI.

FIG. 6B illustrates a Service Diagnostics webpage in the DPM service mode, in one embodiment of the GUI.

FIG. 6C illustrates a Service History webpage in the DPM service mode, in one embodiment of the GUI.

FIG. 6D illustrates a Service Heater Diagnostics webpage in the DPM service mode, in one embodiment of the GUI.

FIG. 6E illustrates a Service Calibration Parameters webpage in the DPM service mode, in one embodiment of the GUI.

FIG. 7A illustrates a Factory webpage in the DPM factory mode, in one embodiment of the GUI.

FIG. 7B illustrates a Factory Calibration Data webpage in the DPM factory mode, in one embodiment of the GUI.

FIG. 7C illustrates a Factory Heater Diagnostics webpage in the DPM factory mode, in one embodiment of the GUI.

FIG. 7D illustrates a Factory Uploader—Downloader webpage in the DPM factory mode, in one embodiment of the GUI.

FIG. 7E illustrates an internet browser window that is opened upon selection by a user of the help tab in any mode, in one embodiment of the GUI.

### DETAILED DESCRIPTION

A method and system are described for monitoring a sensor. In one embodiment of the method and system described below, the sensor may be a Digital Process Manometer (DPM). A Graphical User Interface (GUI) may be accessible via an Ethernet connection to the sensor, and may allow anyone having access to the sensor to monitor it in real time. The GUI may be embedded into the DPM, and may require for display thereof only a standard Ethernet connection to any computer equipped with an internet web browser.

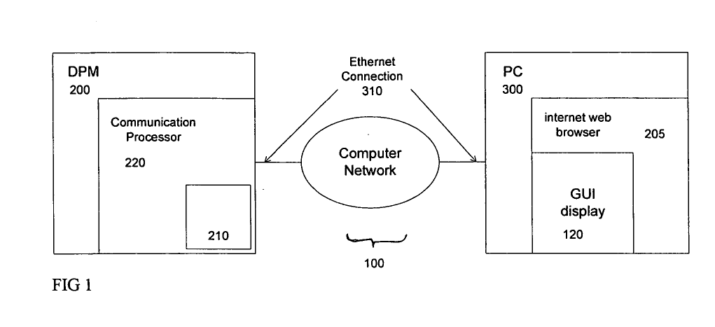

FIG. 1 is a schematic block diagram of one embodiment of a system 100 for monitoring a sensor 200. In the embodiment described below, the sensor 200 may be a Digital Process Manometer (DPM) 200, configured to measure the pressure of gases and vapors. The DPM 200 may have a WebPage 205, through which information relating to the DPM 200 may be accessed by viewers of the WebPage 205. In this patent, the term “WebPage” will refer to a base Uniform Resource Locator (URL) for a particular DPM 200 (or other type of sensor).

In overview, the system 100 may include a computer application embedded in the sensor 200 for generating a GUI 120 that can be displayed on the WebPage 205 of the DPM 200. In particular, the GUI 120 may display information relating to the sensor 200 from any computer 300 that is connectable to the DPM 200 via a standard Ethernet connection 310, and that has any one of several standard internet web browsers for accessing the WebPage 205 of the DPM 200. These internet web browsers may include, but are not limited to: Microsoft Internet Explorer, Netscape, and Mozilla.

The GUI 120 may be embedded into the DPM 200, and may require only a standard Ethernet connection to the user computer 300 equipped with the internet web browser; no additional software is needed. A computer application for generating the GUI may include computer-usable instructions stored in a computer-readable medium 210 embedded within the sensor 200. The computer-usable instructions may, when read and executed by a processor, cause the processor to generate the GUI 120 that is accessible from the WebPage 205 of the DPM 200. In other words, the computer-readable medium 210 contains the WebPage code.

In the illustrated embodiment, the DPM 200 may be a capacitance manometer configured to determine the pressure of a gas by measuring the change in capacitance between a diaphragm and an adjacent electrode. The DPM 200 may include standard electronic circuitry, including inter alia a signal processor, an oscillator, a bridge circuit, and an amplifier, and as well as an internal processing system. The internal processing system of the DPM 200 may include a communication processor 220. The communication processor 220 may include an embedded web browser 230 that allows the DPM 200 to communicate with any computer that is connectable to the Ethernet network the DPM is connected to. In an embodiment of the DPM 200 in which the DPM 200 may be operated at very high temperatures (up to 100° C.), the DPM 200 may also include a heater.

In one embodiment of the system 100, the GUI 120 may include a plurality of objects selectable by a user, and a plurality of browser windows. Each browser window may be associated with one of the objects. The plurality of user-selectable objects may, for example, be a plurality of tabs. As described in further detail below, the plurality of tabs may include, but are not limited, to the following: a device tab, a plot tab, a diagnostics tab, a configuration tab, a service tab, a factory tab, a signout tab, and a help tab.

Each one of the plurality of browser windows may be opened, upon selection by the user of the tab associated with that browser window. Each browser window, when opened, may display a corresponding subpage of the WebPage of the DPM 200. As explained earlier, the term “WebPage” in this patent refers to a base Uniform Resource Locator (URL) for a particular DPM 200 (or other type of sensor). The term “webpage” in this patent will refer to a subpage within the WebPage. Each subpage may contain a different type of information relating to the DPM 200.

In one embodiment of the system 100, the GUI 120 may offer three display modes for the user, once a user is connected to the DPM WebPage: a user mode, the service mode, and the factory mode.

In one embodiment of the GUI 120, the user mode may be the default mode for the DPM 200. Anyone connecting to the DPM 200 via an Ethernet connection without entering special codes or passwords may see computer screens or other interfaces that are displayed in the user mode. In one embodiment of the GUI 120, in the user mode four tabs may be shown in the upper left-hand side of the computer screen or other interface, and one tab may be shown on the right-hand side. Specifically, the four tabs shown on the left may be the device tab, the plot tab, the diagnostics tab, and the configuration tab, and the one tab shown on the right may be the help tab. The GUI functionality for these five tabs will be described further below.

The service mode may be intended for authorized service personnel, and may allow the service personnel to access parameters and other information in the DPM 200 for troubleshooting and diagnostics for both the DPM 200 and connected processing systems. Special codes or passwords may be required to access the features available in the service mode, i.e. the service mode may be an access-restricted mode that is only accessible to, and selectable by, users who provide a correct access password. In one embodiment of the GUI, five tabs may be shown in the upper left-hand side of a computer screen or other interface, and two tabs shown on the right, in the service mode. The five tabs shown on the left may be the device tab, the plot tab, the diagnostics tab, the configuration tab, and the service tab, while the two tabs shown on the right may be the sign out tab and the help tab. The GUI functionality for these seven tabs are described further below. Indication that the DPM 200 is in the service mode may be provided in the footer of the webpage.

The factory mode may be intended for authorized factory personnel, and may allow the factory personnel to access parameters and other information in the DPM 200 for troubleshooting, diagnostics, and calibration of the DPM 200. Special codes or passwords may be required to access the features available in factory mode, i.e. the factory mode may be an access-restricted mode that is only accessible to, and selectable by, users who provide a correct access password. In one embodiment of the GUI 120, six tabs may be shown in the upper left-hand side of a computer screen or other interface, and two tabs shown on the right, in the factory mode. The six tabs shown on the left may be the device tab, the plot tab, the diagnostics tab, the configuration tab, the service tab, and the factory tab, while the two tabs shown on the right may be the sign out tab and the help tab. The GUI functionality for these eight tabs are described further below. Indication that the DPM 200 is in the factory mode may be provided in the footer of the webpage.

The GUI 120 may further include a plurality of buttons. For example, the “Device Events Page” button and the “Press to Refresh” button, described further below, may be common elements found in all webpages and in all display modes. Depending on user configurations and the overall system state, these elements may or may not be shown.

Most subpages in the GUI 120 may have other elements that are common to other webpages. These common elements may include, but are not limited to: manufacturer Logos, a number of tabs across the top of a webpage, and model and serial numbers for the DPM 200 across the bottom of a webpage.

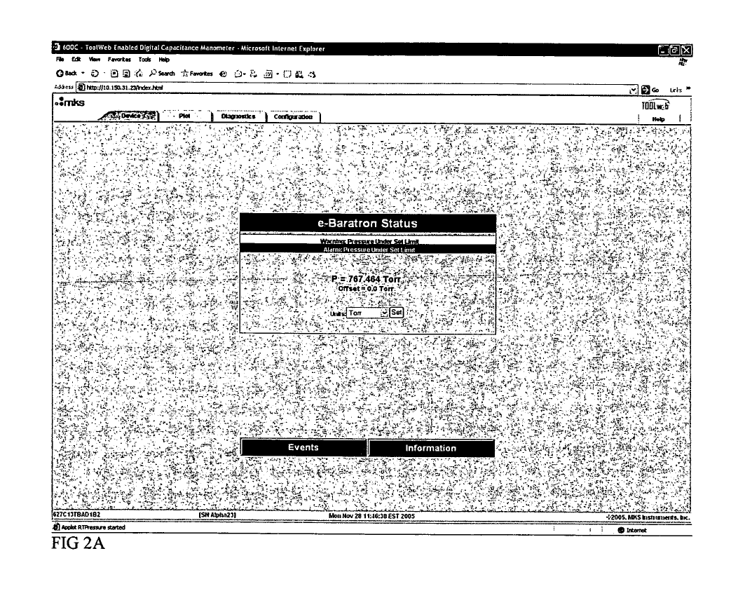

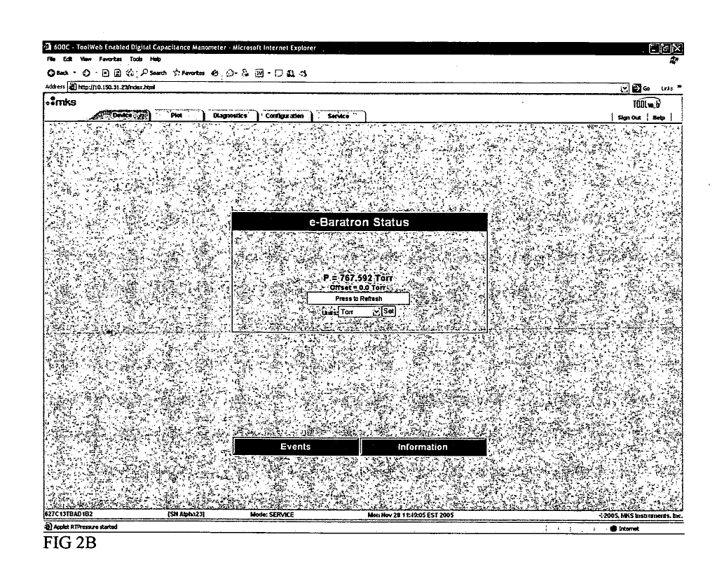

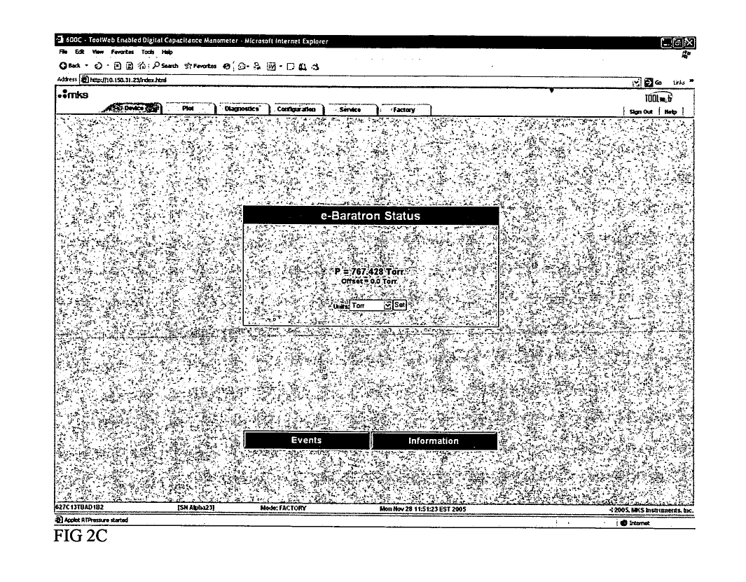

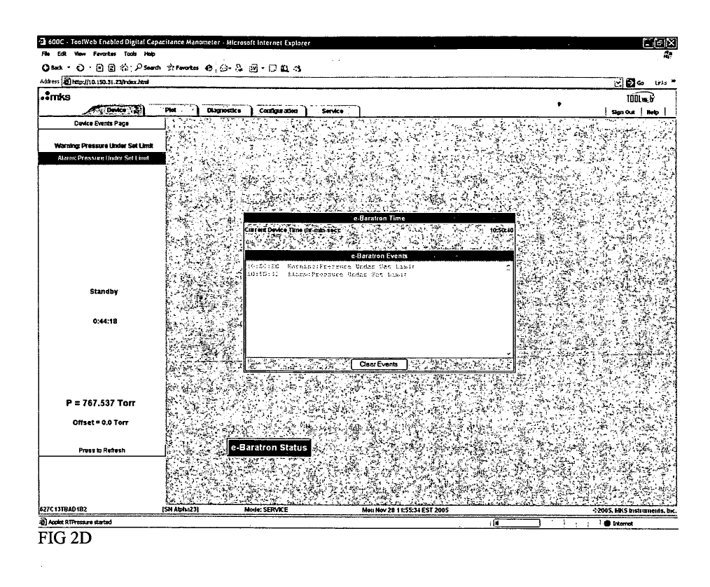

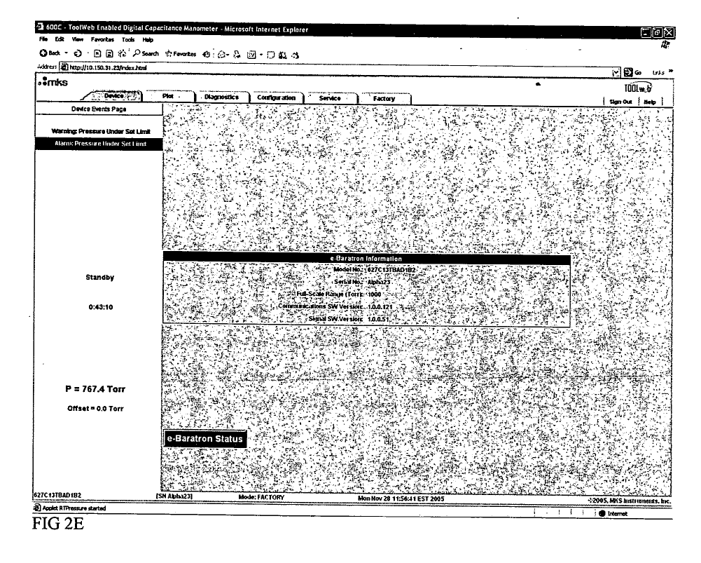

FIG. 2A illustrates an e-Baratron Status webpage, in a DPM user mode in one embodiment of the GUI. In this embodiment, the illustrated e-Baratron Status webpage may be the default webpage in the user mode. Anyone connecting to the DPM WebPage 205 via an Ethernet connection, without entering any special codes or passwords, may see the screen shown in FIG. 2A, in which the device tab is shown as being selected. In the user mode e-Baratron Status webpage shown in FIG. 2A, the real-time pressure may have been turned on, and one warning and 1 alarm event may be shown.

As seen in conjunction with FIGS. 2B and 2C below, in one embodiment of the GUI the e-Baratron Status webpage may be a default webpage, not only in the user mode, but also in the service mode and the factory mode. In this embodiment, the e-Baratron Status webpage may be displayed every time a “Refresh” button, or a “Go” button is pressed in the Internet Explorer, regardless of the display mode that the DPM is in.

FIG. 2B illustrates an e-Baratron Status webpage in a DPM service mode, in one embodiment of the GUI. In this embodiment, the illustrated e-Baratron Status webpage may be the default webpage in the service mode. After connecting to the DPM WebPage via an Ethernet connection and upon correct entry of an access code or password for the service mode, a user may see the screen shown in FIG. 2B. In the service mode e-Baratron Status webpage shown in FIG. 2B, the real-time pressure has been turned on, and no warning or alarm events are shown.

FIG. 2C illustrates an e-Baratron Status webpage in a DPM factory mode, in one embodiment of the GUI. In this embodiment, the illustrated e-Baratron Status webpage may be the default webpage in the factory mode. After connecting to the DPM WebPage via an Ethernet connection and upon correct entry of an access code or password for the factory mode, a user may see the screen shown in FIG. 2C. In the factory mode e-Baratron Status webpage shown in FIG. 2B, the real-time pressure has been turned on, and no warning or alarm events are shown.

As seen in FIGS. 2A, 2B, and 2C, the e-Baratron Status webpage may have simultaneous displays of the DPM's output signal (showing e.g. the measured value of the pressure or vacuum), the operating status of the DPM via colored bars, and a selection of units of pressure measurement that the user may choose, including but not limited to Torr, mmHg, mBar, and psi.

FIG. 2D illustrates an e-Baratron Event webpage in the DPM service mode, in one embodiment of the GUI 120. In this embodiment, this webpage may show a list of the events recorded by the DPM's internal processing system that may be reset or cleared by the user. This list may include, but are not limited to, the following events: the number of times the DPM has been exposed to pressures higher than its full-scale range; whether or not user-selectable pressure limits have been exceeded (shown in the diagram); communications failures; and one or more sensor failure modes. A “Clear Events” button may be used to remove these messages from the screen. In one embodiment of the GUI 120, this page may be accessed via an “Events” link at the bottom of the e-Baratron Status webpage. A “Press to Refresh” button may be used to refresh, if the real-time refresh had been turned off.

The time stamps shown with each event on the webpage illustrated in FIG. 2D may be relative to the current device time, shown under “e-Baratron Time” in one embodiment of the GUI 120. The DPM 200 may not have a real-time clock but may keep track of the time elapsed during which the DPM has been operational.

A common element that may be displayed on all webpages except for the e-Baratron Status webpage, the Plot webpage (described below), and the Help webpage (described below) may be the real-time pressure display. This display may be inside a white panel, which shown in FIG. 2D as being located on the left side of the e-Baratron Event webpage. In one embodiment, the GUI 120 may show a continuous display of the system pressure/vacuum, any zero offset, and the device status, on this white panel.

Another common element shown on the white panel may be a “Standby” message and countdown timer that may be displayed, when the DPM unit is initially powered. After a countdown time determined by the DPM model, this message and timer may no longer be shown, and the message “Sensor Has Reached Control Temperature” may be shown. This may help users to give the DPM 200 time to come up to its normal operating temperature.

FIG. 2E illustrates an e-Baratron Information webpage in the DPM factory mode, in one embodiment of the GUI. The e-Baratron Information webpage, accessible from all three display modes when a user selects the device tab, may show user-viewable, unit-specific attributes of the DPM 200, such as serial number, model number, and software revision number. Such attributes may include version numbers of the communication processor 220 and of a signal processor that may be part of standard electronic circuitry in the DPM 200. In the user mode and the service mode, the version numbers may be limited to major and minor revision numbers. In the factory mode, two additional fields indicating software build numbers may be available. The e-Baratron Information webpage may be accessed via an “Information” link at the bottom of the e-Baratron Status page.

As seen in FIG. 2E, on the left side of the e-Baratron Information webpage, a dynamically refreshed display of the pressure/vacuum output, status of the unit (operational/green, warning/yellow, or failed/red) may be shown, as well as the most recent troubleshooting messages. Also shown on the sidebar may be the “Standby” message and countdown timer, described above.

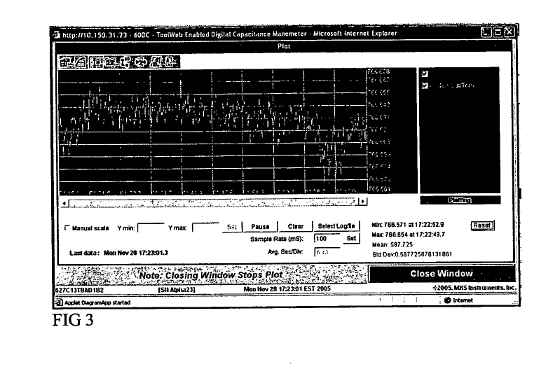

FIG. 3 illustrates a Plot webpage in the DPM user mode, in one embodiment of the GUI. The Plot webpage may be accessed when a user selects the Plot tab. Upon selection by the user of the Plot tab, a separate browser window may open, to display the Plot webpage shown in FIG. 3. Regardless of what other tab is selected thereafter, as long as the original Plot webpage is not closed, it may be brought to the front/top, when the plot tab is selected.

The Plot webpage may show real-time graphical displays of the DPM's digital output signal and the analog output signal as a function of time. The display may be modified to show shorter and longer scan intervals. The Plot webpage may allow the user to not only view the pressure data graphically with respect to the PC clock, but also log the pressure data to a file that has a time and date stamp with each data point. The pressure units selected by the user from the e-Baratron Status webpage may automatically be displayed here. This may allow the user to see the data scaled to the desired pressure units.

The Plot webpage may also provide a user with other features, including but not limited to: zooming in; adjusting a sample rate; selecting graphing colors; selecting different scales; and making the axes show with the mouse cursor. These axes may be cross-hairs, showing the pressure and time at the location of the mouse cursor on the plot.

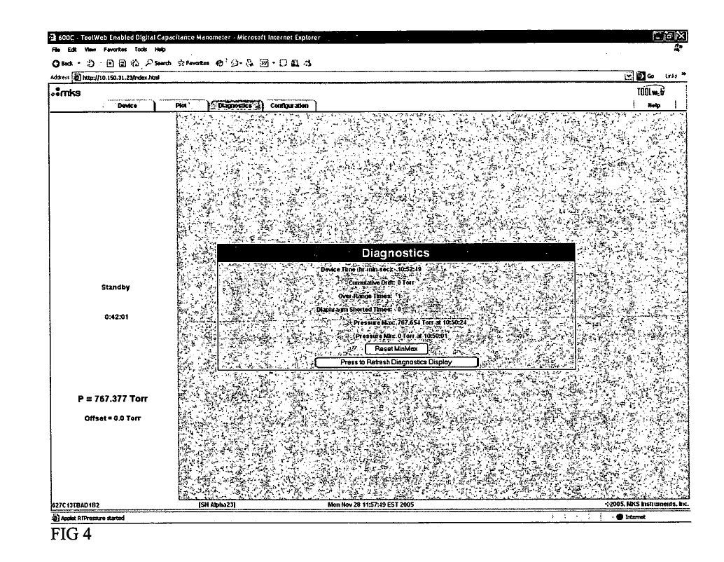

FIG. 4 illustrates a Diagnostics webpage in the DPM user mode, in one embodiment of the GUI. The Diagnostics webpage may be accessed when a user selects the Diagnostics Tab. The Diagnostics webpage may show specific information concerning the function of the DPM. For example, the user may see a number of parameters of the DPM 200, including but not limited to: device time, cumulative zero drift, the number of times when the DPM 200 has been exposed to pressure above its full-scale range, and maximum and minimum values of the pressure, with associated user-selected units and time stamps.

Two buttons may be available for users on the Diagnostics webpage: a “Reset Min/Max” button, and a “Press to Refresh Diagnostics Display” button. The “Reset Min/Max” button, when selected by a user, may clear the stored minimum and maximum values of the pressure, and the associated time stamps. The “Press to Refresh Diagnostics” button, when selected by a user, may refresh the webpage containing the Diagnostic information, allowing the user to check for changes in the Minimum and Maximum values.

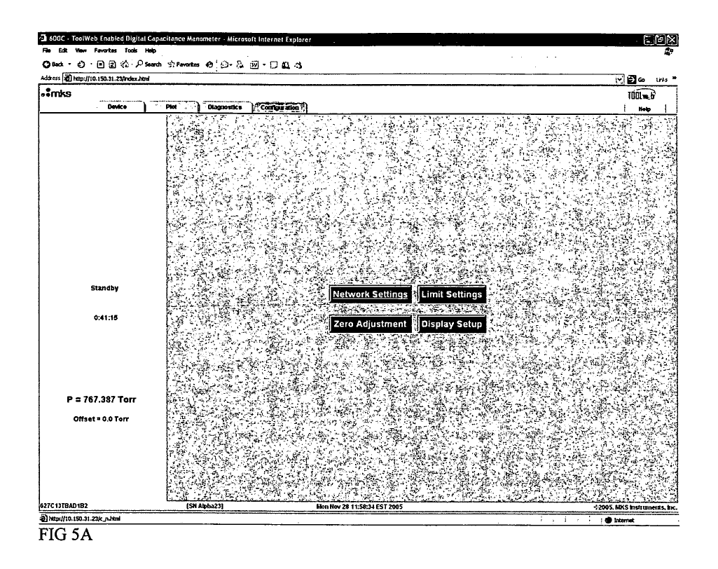

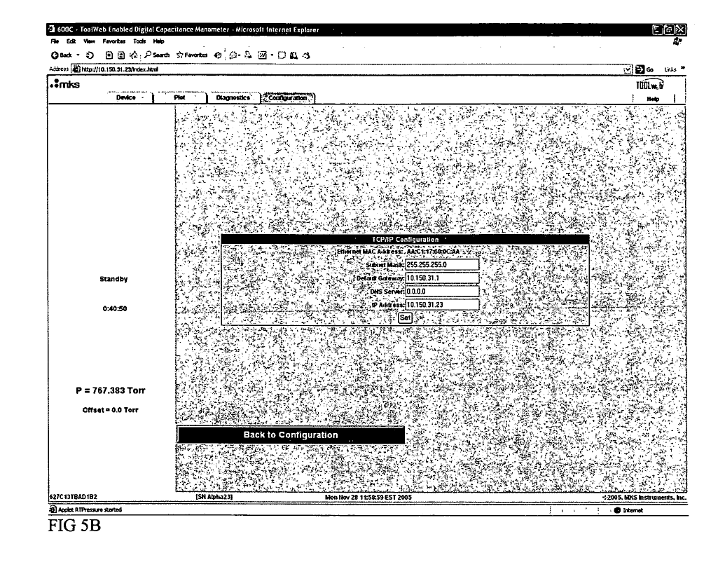

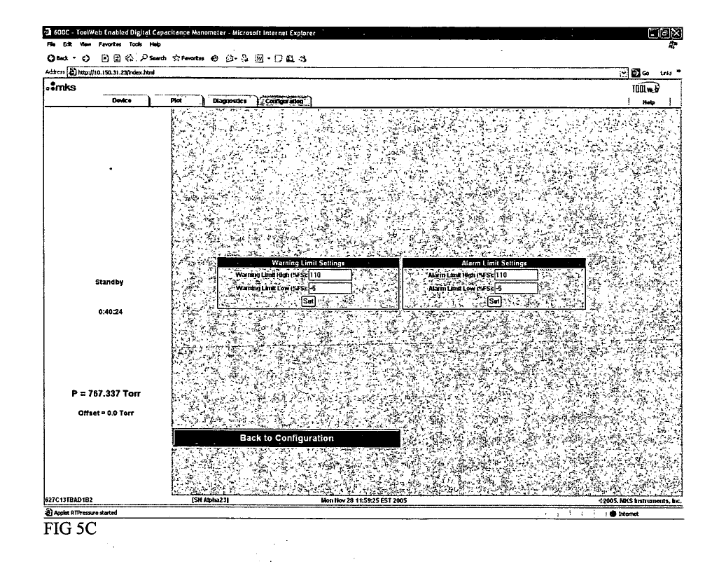

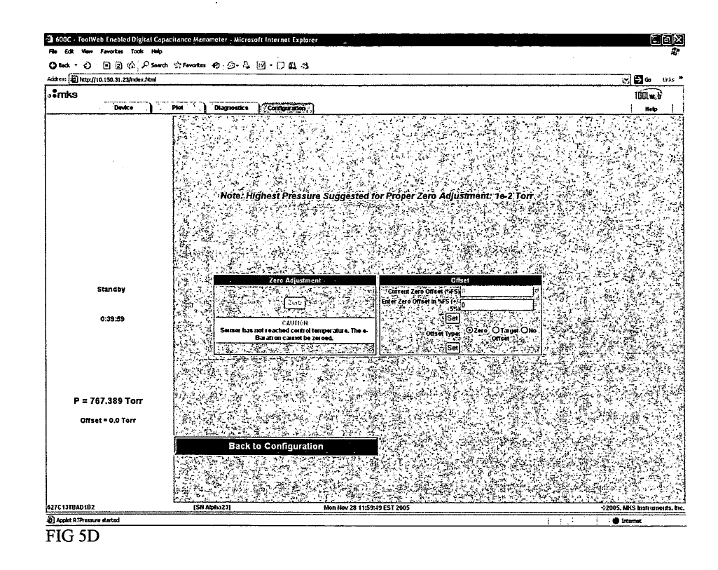

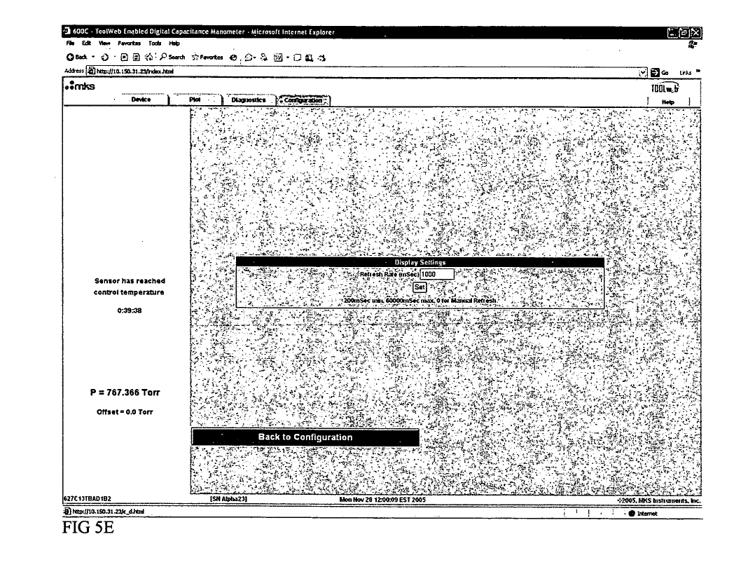

FIG. 5A illustrates a Configuration webpage in the DPM user mode, in one embodiment of the GUI. The Configuration webpage is accessed by a user by selecting the Configuration Tab. The Configuration webpage may give access to user-configurable parameters. These parameters may include, but are not limited to, the following: network settings, zero adjustments, warning and alarm limit settings, and display setup.

As described earlier, the real-time pressure display and the “Standby” message may be common elements in all webpages except for e-Baratron Status, Plot, and Help webpages.

FIG. 5B illustrates a Configuration Network Settings webpage in the DPM user mode, in one embodiment of the GUI. The Configuration Network Settings webpage may be accessed via the “Network Settings” link on the Configuration webpage, described above. This webpage may allow the user to access the Network parameters of the DPM, which in turn may allow the DPM 200 to communicate with the user's network or other instrumentation. For example, this webpage may allow the user to change the IP (Internet Protocol) address for the device, as well as other communications parameters, so that the device can communicate with the user's network or instrumentation. The Network parameters available to be changed may include, but are not limited to the following: the IP address of the DPM WebPage; the default gateway; the subnet mask; and the DNS server. A “Set” button may be provided for users, in the Configuration Network Settings webpage, to change these parameters to user-defined values. In other words, pressing the “Set” button on this webpage may trigger the storage and application of the Network parameters that have been changed by the user.

FIG. 5C illustrates a Configuration Limit Settings webpage in the DPM user mode, in one embodiment of the GUI. The Configuration Limit Settings webpage may be accessed via a “Limit Settings” link provided on the Configuration webpage. The Configuration Limit Settings webpage may provide the user with two independent software-based alarm limits (upper and lower limits) and two independent software-based warning limits (upper and lower limits) to set. The user may set each limit in units of a percentage of the DPM's full-scale pressure range. When a limit is exceeded, an event may be indicated in the real-time pressure display for that event. For example, alarm events may shown in red, and warning events may be shown in yellow.

Capacitance manometers such as the DPM are precision electromechanical devices. Like most tightly toleranced devices, temperature and other environmental factors may have an effect on performance. In the case of a capacitance manometer, the electrical output at zero pressure may be subject to changes due to shipping and handling. For this reason, capacitance manometers may require zeroing upon installation, and the zero may have to be monitored on a routine basis.

FIG. 5D illustrates a Configuration Zero Adjustment webpage in the DPM user mode, in one embodiment of the GUI. This webpage is intended to permit zeroing of the DPM through the GUI and optionally, the introduction of a user-defined Offset in the pressure reading when the DPM is zeroed. This page may be accessed via a “Zero Adjustment” link on the Configuration webpage.

For the Configuration Zero Adjustment webpage, one of three different messages could be shown. If the sensor has not yet reached it's operating temperature, the message “CAUTION Sensor has not reached control temperature. The e-Baratron cannot be zeroed.” May be displayed. If this message is displayed, the DPM may not be zeroed and the “Zero” button may be disabled. If the pressure or vacuum is below the resolution of the DPM, or the pressure or vacuum is above the DPM's resolution but less than 20% of the full-scale range, then a message “ACCEPTABLE PRESSURE System pressure is suitable for zeroing the e-Baratron capacitance manometer” may appear. The “Zero” button may then be enabled and the user may zero the DPM.

If the pressure or vacuum is above 20% of the full-scale range, the GUI may display the following message: “CAUTION System pressure is higher than 20% FS. The e-Baratron cannot be zeroed.” If this message is displayed, the DPM 200 may not be zeroed, and the “Zero” button may be disabled.

If the user sets the Offset Type selection to “No Offset”, the DPM may use the pressure/vacuum it is currently measuring as pure vacuum when the “Zero” button (either on the WebPage or the physical button on the DPM) is pressed, and may adjust its analog and digital output to zero. If the user sets the Offset Type to “Zero” and the Zero Offset selection numerically to a non-zero value from −5 to +5% FS (Fullscale), the DPM may use the pressure/vacuum it is currently measuring as pure vacuum when the “Zero” button (either on the WebPage or the physical button on the DPM) is pressed. The DPM may then adjusts it's analog and digital output to the Zero Offset value.

If the user sets the Offset Type to “Target” and the Target Offset selection numerically to a value from −5 to 5% FS, the DPM may use the pressure/vacuum it is currently reading as a known positive pressure when the “Zero” button (either on the WebPage or the physical button on the DPM) is pressed. The DPM may then adjust it's analog and digital output to the Target Offset value.

FIG. 5E illustrates a Configuration Display Setup webpage in the DPM user mode, in one embodiment of the GUI. The Configuration Display Setup webpage may be accessed via a “Display Setup” link on the Configuration webpage. This webpage may allows users to change the real-time pressure display refresh rate, which may affect how frequently the webpage data is updated with new information from the DPM. The rate may be shown in milliseconds of time and may have a 200 millisecond minimum, 60000 millisecond (1 minute) maximum, and may be turned off altogether by setting the refresh rate to zero milliseconds.

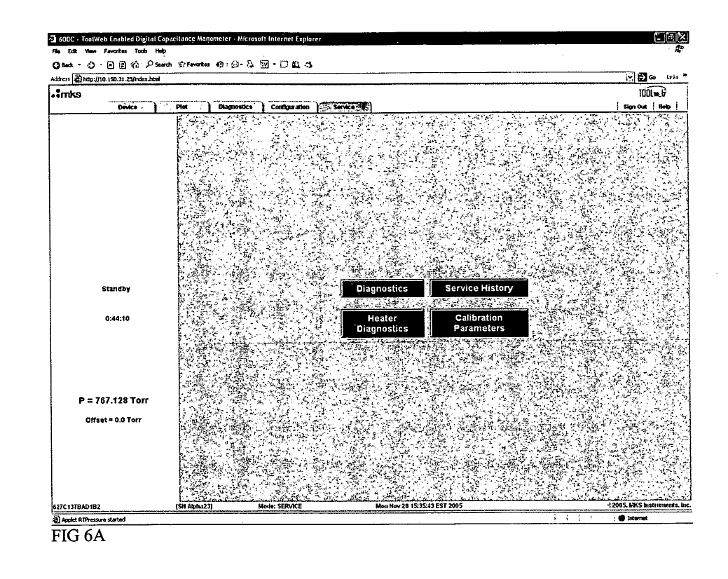

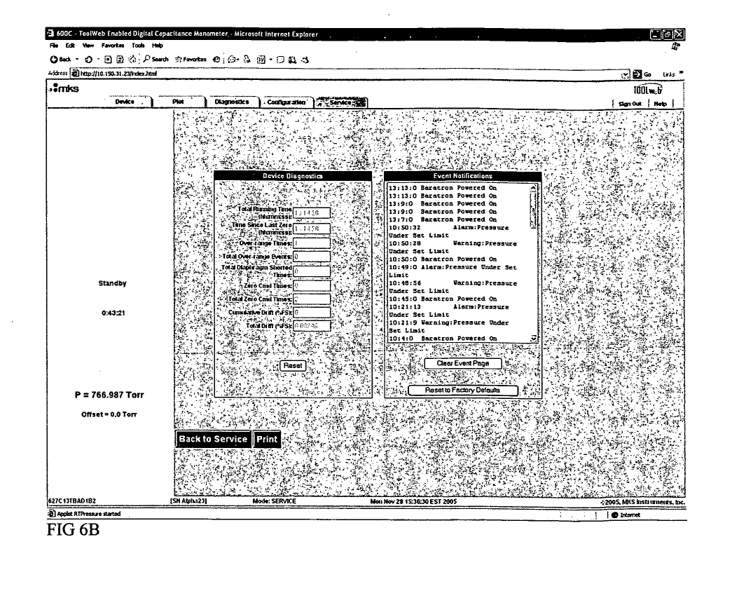

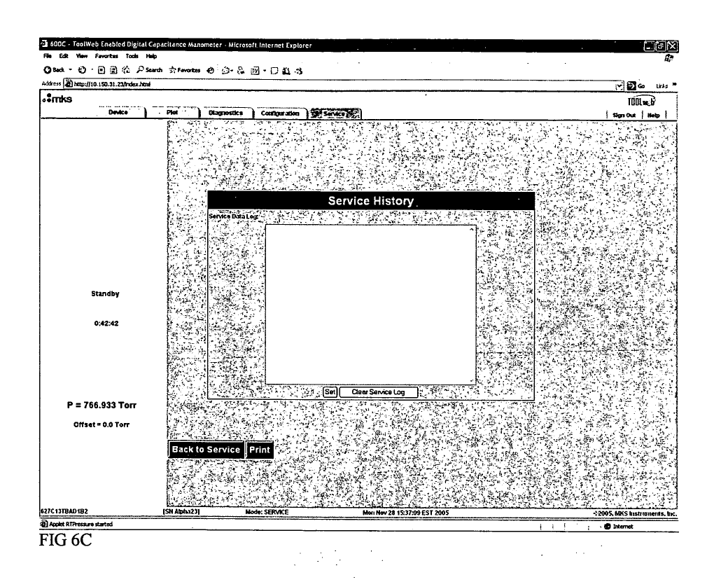

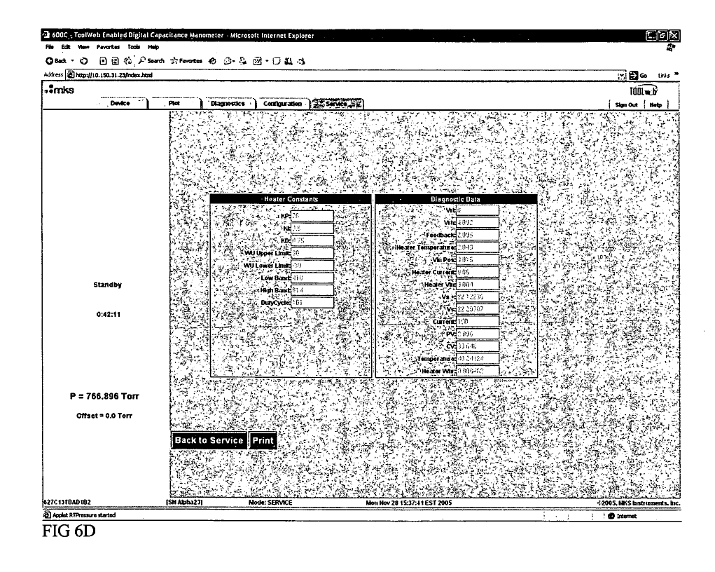

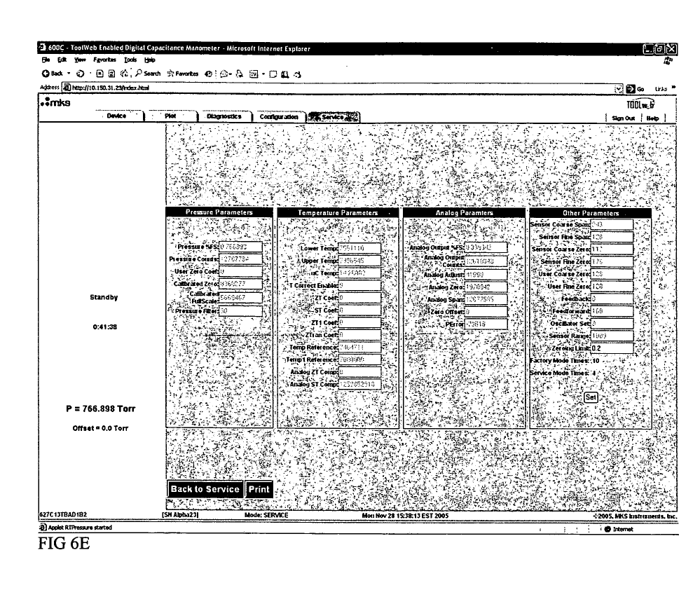

FIG. 6A illustrates a Service webpage in the DPM service mode, in one embodiment of the GUI. The Service webpage may be accessed by users by selecting the Service Tab. The Service webpage may provide service personnel with access to parameters such as Service Diagnostics, Service History, Heater Diagnostics (read only), and Calibration Parameters (read only).

FIG. 6B illustrates a Service Diagnostics webpage in the DPM service mode, in one embodiment of the GUI. On this webpage, the user may see some parameters of the DPM such as device time (see section 2.2), the time elapsed since the DPM was last zeroed, two values of Zero Drift (drift since last service and total lifetime drift), two values representing the number of times the DPM has been zeroed (the times zeroed since last service and the total lifetime times zeroed), two values representing the number of times the DPM has been over it's full-scale range (times over full-scale range since last service and the total lifetime times over full-scale range), and the number of times the diaphragm has been shorted.

A “Reset” button may allow service personnel to reset the values accumulated since the last time the DPM was in Service mode. This page may also have an “Event Notification” field that acts as a comprehensive “First-In, First Out” storage of Events that have occurred in the DPM with their associated time-stamps. The “Clear Event Page” button may clear all messages stored in this field.

A “Reset to Factory Defaults” button may reset calibration parameters that may have been modified during zeroing of the DPM. The Service Diagnostics webpage may be accessed by selecting the “Diagnostic” link on the Service webpage.

FIG. 6C illustrates a Service History webpage in the DPM service mode, in one embodiment of the GUI. The Service History webpage may be accessed by selecting the “Service History” link on the Service webpage. This webpage may allow service personnel to store notes regarding the DPM and the time and date of a service action as well as the action performed.

FIG. 6D illustrates a Service Heater Diagnostics webpage in the DPM service mode, in one embodiment of the GUI. The Service Heater Diagnostics webpage may be accessed by selecting the “Heater Diagnostics” link on the Service webpage. This webpage may allow service personnel to view the control settings and diagnostic information for the DPM's heater such as the “Heater Constants”, various voltages and currents within the heater control loop, and the heater temperature. Service personnel may also obtain a hardcopy of this data via the “Print” button on the bottom of the webpage.

FIG. 6E illustrates a Service Calibration Parameters webpage in the DPM service mode, in one embodiment of the GUI. This webpage may allow service personnel to view the calibration parameters in the DPM. The “Other Parameters” field may contain a non-resettable count of the times the DPM has been in both Service and Factory modes. The “Reset to Factory Defaults” button has the same function as described above in conjunction with the Service Diagnostics webpage. Service personnel may also get a hardcopy of this data via the “Print” button on the bottom of the webpage. The Service Calibration Parameters webpage may be accessed by selecting the “Calibration Parameters” link on the Service webpage.

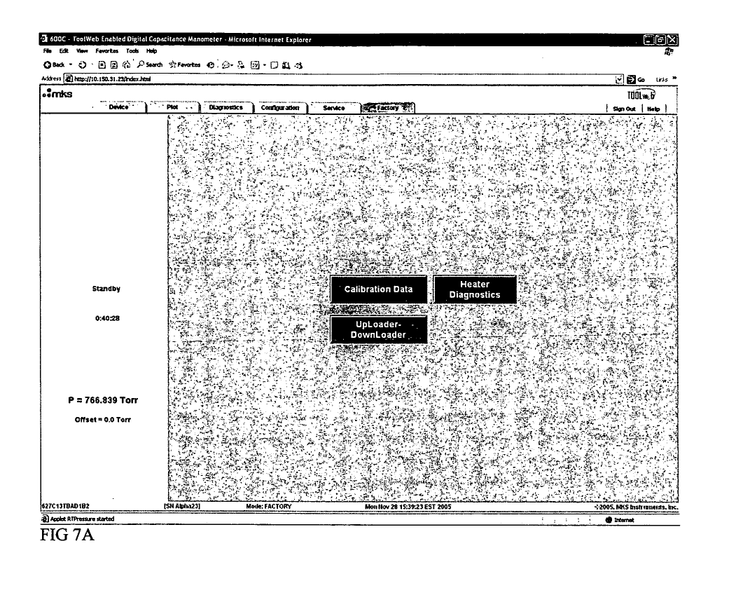

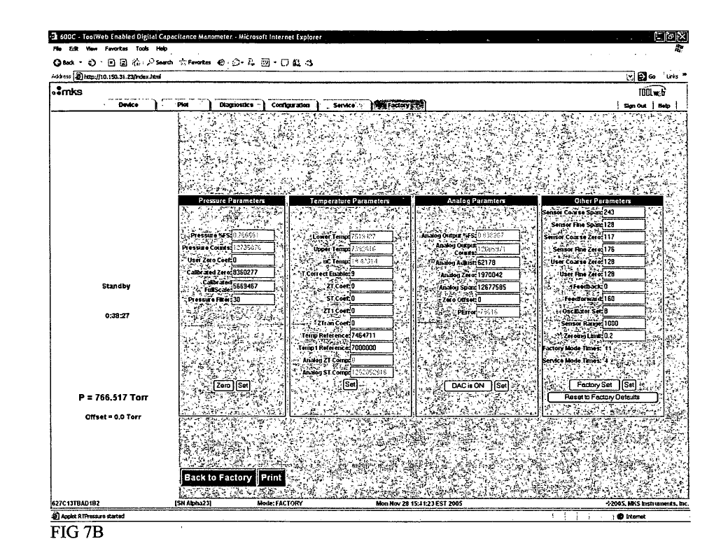

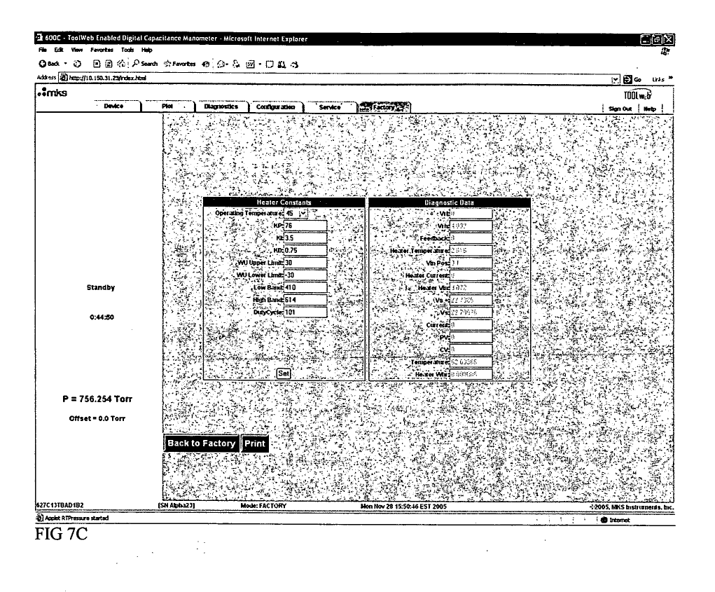

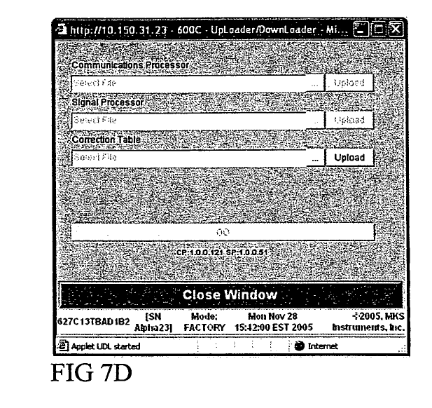

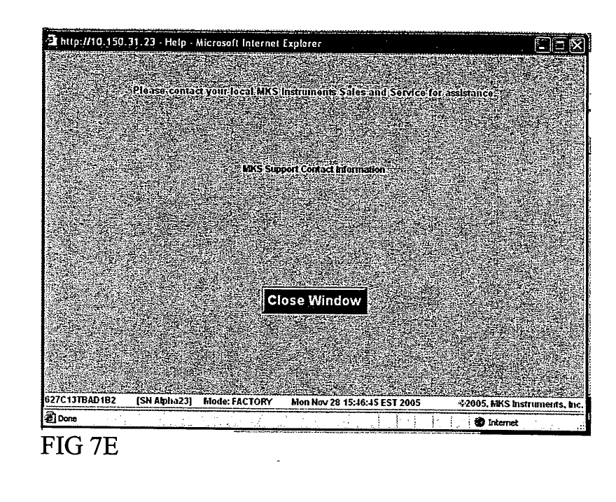

FIG. 7A illustrates a Factory webpage in the DPM factory mode, in one embodiment of the GUI. The Factory webpage may be accessed by selecting the Factory Tab. The Factory webpage may give factory personnel access to parameters such as Calibration Data (read and write), Heater Diagnostics (read and write), the ability to upload firmware or calibration data to the DPM, and the ability to download calibration data from the DPM.

FIG. 7B illustrates a Factory Calibration Data webpage in the DPM factory mode, in one embodiment of the GUI. This webpage may allow factory personnel to view and set the calibration parameters in the DPM. The “Set” buttons at the bottom of each field may cause the DPM to commit the parameters in that field to use. The “Zero” button at the bottom of the “Pressure Parameters” field may have the same functionality as the “Zero” button described in section 5.3 but without the restrictions. The “DAC is ON” button may allow factory personnel to toggle the DAC used for analog output on and off. The “Factory Set” button at the bottom of the “Other Parameters” field may store calibration data that may change during zeroing to a separate location in memory. The “Reset to Factory Defaults” button may have the same function as described above. The “Other Parameters” field may also contain the same non-resettable count of the times the DPM has been in both Service and Factory modes, as described earlier. Factory personnel may also get a hardcopy of this data via the “Print” button on the bottom of the webpage. The Calibration Parameters webpage may be accessed by selecting the “Calibration Parameters” link on the Factory webpage.

FIG. 7C illustrates a Factory Heater Diagnostics webpage in the DPM factory mode, in one embodiment of the GUI. This webpage may allow factory personnel to view and set the control settings for the DPM's heater in the “Heater Constants” field. This webpage may also allow factory personnel to view various voltages and currents within the heater control loop and the heater temperature. After changes are made to the control settings, the “Set” button may cause the DPM 200 to commit them to use. Factory personnel may also get a hardcopy of this data via the “Print” button on the bottom of the page. This Heater Diagnostic webpage may be accessed by selecting the “Heater Diagnostics” link on the Factory webpage.

FIG. 7D illustrates an Uploader-Downloader webpage in the DPM factory mode, in one embodiment of the GUI. The “Uploader-Downloader” webpage may be accessed by selecting an “Uploader-Downloader” link on the Factory webpage. When this link is selected, a new browser window may be opened. This webpage may allow factory personnel to update the firmware in both the signal processor and the communications processor in the DPM 200, read and write a correction table in the DPM 200, and read and write all parameters (user configurations and calibration parameters) in the DPM 200. “Writing” may refer to a process in which data is taken from a file on the connected PC (or other computer 300) and transmitted to the DPM 200. “Reading” may refer to a process in which data is taken from the DPM 200 and stored in a file on the connected PC (or other computer 300). The four gray buttons with the “. . . ” shown in them may be used to select the files that are written to or read from. The file names and directory locations may be displayed in the fields to the left of the buttons. The checkboxes to the right of the four boxes may be used to select whether data is read from or written to the DPM 200. A “GO” button at the bottom may be used to initiate the transfer of data between the computer 300 and the DPM 200. The current version of the firmware for the signal processor and the communications processor firmware may be displayed under the “GO” button.

In the above-described embodiment of the GUI 120, there may be no webpage associated with the signout tab. Selecting the signout tab may simply take the user to the user mode from either the service mode or the factory mode. The signout tab disappears after it is pressed. As for the help tab, a new browser window, shown in FIG. 7E, may be opened upon selection by a user of the help tab.

In sum, a system has been described for monitoring a sensor. The system includes a GUI that allows a user to access information relating to the sensor from any computer as long as the computer is connectable via an Ethernet link to the sensor using a standard internet web browser, and to monitor the sensor in real time.

While certain embodiments of the GUI have been described, it is to be understood that the concepts implicit in these embodiments may be used in other embodiments as well. The protection of this application is limited solely to the claims that now follow.

In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for monitoring a sensor, the system comprising;
a GUI (graphical user interface) accessible from a WebPage of the sensor, the GUI configured to display information relating to the sensor from a computer that is connectable to the internet and has an internet web browser for accessing the WebPage of the sensor; and
a computer-readable medium embedded within the sensor, the computer-readable medium having stored therein computer-usable instructions for a processor, wherein said instructions when executed by the processor cause the processor to generate said GUI.

2. The GUI of claim 1, wherein the GUI comprises:
a plurality of objects selectable by a user;
a plurality of browser windows each associated with one of the objects,
wherein each of the browser windows are opened upon selection by the user of the associated object; and
wherein each of the browser windows displays, when opened, a corresponding subpage of the WebPage of the sensor, each subpage containing a different type of information relating to the sensor.

3. The system of claim 1, wherein the sensor comprises a digital manometer configured to measure pressure of gases and vapors.

4. The system of claim 3, wherein the plurality of user-selectable objects comprises a plurality of user-selectable tabs.

5. The system of claim 4, wherein the plurality of tabs include at least one of: a device tab, a plot tab, a diagnostics tab, a configuration tab, a service tab, a factory tab, a sign out tab, and a help tab.

6. The system of claim 5, wherein the GUI is further configured to display the information relating to the sensor in one of a plurality of user-selectable display modes.

7. The system of claim 6,
wherein the plurality of display modes comprises at least one of a user mode, a service mode, and a factory mode;
wherein the user mode is a default mode accessible by all users who connect to the WebPage of the sensor; and
wherein the service mode and the factory mode are access-restricted modes that are only accessible to, and selectable by, users who provide an access password.

8. The system of claim 7,
wherein the GUI is configured to display a first interface that includes the device tab, the plot tab, the diagnostics tab, the configuration tab, and the help tab, in response to selection by a user of the user mode;
wherein the GUI is configured to display a second interface that includes the device tab, the plot tab, the diagnostics tab, the configuration tab, the service tab, the signout tab, and the help tab, in response to selection by a user of the service mode; and
wherein the GUI is configured to display a third interface that includes the device tab, the plot tab, the diagnostics tab, the configuration tab, the service tab, the factory tab, the signout tab, and the help tab, in response to selection by a user of the factory mode.

9. The system of claim 8, wherein the selection by the user of the user mode comprises connection by the user to the WebPage of the sensor.

10. The system of claim 8, wherein the GUI is configured to display at least one of an e-Baratron Status webpage, an e-Baratron Events webpage, and an e-Baratron Information webpage, in response to selection by a user of the device tab.

11. The system of claim 10,
wherein the sensor comprises a DPM (Digital Process Manometer);
wherein the e-Baratron Status webpage contains information relating to at least one of: an output signal of the DPM, an offset from zero of the DPM, an operating status of the DPM, and a selection of user-selectable units of DPM measurements;
wherein the e-Baratron Events webpage contains information relating to a list of events recorded by a microprocessor within the DPM; and
wherein the e-Baratron Information webpage displays a plurality of attributes of the DPM.

12. The system of claim 8, wherein the GUI is configured to display a Plot webpage in response to selection by the user of the Plot tab.

13. The system of claim 12,
wherein the Plot webpage contains pressure data relating to pressure measurements obtained by the DPM, and wherein the Plot webpage allows the user to view the pressure data graphically.

14. The system of claim 8, wherein the GUI is configured to display a Diagnostics webpage in response to selection by the user of the diagnostics tab.

15. The system of claim 14,
wherein the Diagnostics webpage contains information relating to one or more diagnostics parameters for the DPM; and
wherein the diagnostics parameters comprise one or more of:
a device time parameter indicative of the time during which the DPM has been operational;
a drift parameter relating to cumulative zero drift;
a parameter indicative of the number of times when the DPM has been exposed to pressure above its full-scale range; and
parameters relating to the maximum and minimum values of the pressure measurements by the DPM.

16. The system of claim 8, wherein the GUI is configured to display at least one of a Configuration webpage, a Configuration Network Settings webpage, a Configuration Limit Settings webpage, a Configuration Zero Adjustment webpage, and a Configuration Display Setup webpage, in response to selection by the user of the configuration tab.

17. The system of claim 16,
wherein the Configuration webpage contains information about one or more user-configurable parameters, the user-configurable parameters relating to at least one of: network settings, zero adjustments, warning and alarm limit settings, and display setup;
wherein the Network Settings webpage contains information about one or more network parameters, the network parameters relating to at least one of an IP address and a default gateway, the IP address and the default gateway allowing the DPM to communicates with a network of the user.

18. The system of claim 16,
wherein the Limit Settings webpage contains information about one or more alarm and warning limits, the alarm and warning limits relating to upper and lower limits on alarms and warnings that users can set in units of percentage of the DPM's full scale range of pressure values; and
wherein the Limit Settings webpage is configured to display a corresponding event when a limit is exceeded.

19. The system of claim 16,
wherein the Zero Adjustment webpage contains information that allows the user to zero the DPM through the GUI, and wherein the Zero Adjustment webpage further contains information that allows the user to introduce a user-defined offset in a pressure reading by the DPM when the DPM is zeroed; and
wherein the Display Setup webpage contains information that allows the user to change a real-time pressure display refresh rate, the real-time pressure display refresh rate representing a frequency with which data in the webpages of the e-Baratron are updated.

20. The system of claim 7, wherein the GUI is configured to display at least one of a Service webpage, a Service Diagnostics webpage, a Service History webpage, a Service Heater Diagnostics webpage, and a Service Calibration Parameters webpage, in response to selection by the user of the service tab.

21. The system of claim 18,
wherein the Service webpage contains information about service parameters, the service parameters relating to one or more of: service diagnostics, service history, heater diagnostics, and calibration parameters;
wherein the Service Diagnostics webpage contains information about service diagnostics parameters, the service diagnostics parameters relating to at least one of: device time during which the DPM has been operational; time elapsed since the DPM was last zeroed; zero drift values; number of times the DPM has been zeroed; number of times the DPM has exceeded is full-scale range of pressure measurement values;

22. The system of claim 18,
wherein the Service History webpage is configured to allow service personnel to store therein data relating to time, date, and description of service action performed on the DPM;
wherein the Service Heater Diagnostics webpage contains information relating to control settings and diagnostic information for a heater of the DPM;
wherein the Service Calibration Parameters webpage contains information relating to calibration parameters of the DPM.

23. The system of claim 8, wherein the GUI is configured to display at least one of a Factory webpage, a Factory Calibration Data webpage, a Factory Heater Diagnostics webpage, and a Factory Uploader-Downloader webpage, in response to selection by the user of the factory tab.

24. The system of claim 23,
wherein the Factory webpage provides factory personnel access to information relating to calibration data parameters and heater diagnostics parameters, and allows the factory personnel to upload the calibration data to the DPM and to download the calibration data from the DPM;
wherein the Factory Calibration Data webpage contains information about DPM calibration parameters, and allows the factory personnel to view and set the DPM calibration parameters;
wherein the Factory Heater Diagnostics webpage contains information about control settings for a heater of the DPM;
wherein the Uploader-Downloader webpage allows the factory personnel to read and write one or more parameters in the DPM, and to update firmware in one or more processors in the DPM.

25. A computer-readable medium having stored therein computer-usable instructions for a processor, wherein said instructions when executed by said processor causes said processor to generate a GUI (graphical user interface) on a user computer connected to a WebPage of a sensor, the GUI configured to display information relating to the sensor and comprising:
a plurality of user-selectable objects;
a plurality of browser windows, each browser window associated with one of the objects;
wherein each of the browser windows are opened on selection by a user of the associated object;
wherein each of the browser windows displays, when opened, a corresponding subpage of the internet WebPage of the sensor, each subpage containing a different type of information relating to the sensor; and
a region within a display screen of the user computer configured to display the plurality of user-selectable objects and the plurality of browser windows.

26. The system of claim 25, wherein the computer-readable medium is embedded within the sensor.

27. The system of claim 25, wherein the plurality of user-selectable objects comprise a plurality of user-selectable tabs.

28. The system of claim 25, wherein the GUI further comprises:
a region within a display screen of the user computer configured to display the plurality of user-selectable objects and the plurality of browser windows.
